(19) United States
(12) Patent Application Publication
(10) Pub. No.: US 2009/0076835 A1
(43) Pub. Date: Mar. 19, 2009

(54) Customer service communication system and method

(76) Inventors: Garry Lyle Carter, Dublin, CA (US); Robert Poon, Cupertino, CA (US); Matthew Rudd Canaday, Berkeley, CA (US); Rudd Hoover Canaday, San Francisco, CA (US); Wendell Eugene Martin, Berkeley, CA (US)

Correspondence Address: Gerald L. Robertson, 1110 Castle Oaks Drive, Napa, CA, 94558-1576, US

(21) Appl. No.: 11/901,991

(22) Filed: Sep. 19, 2007

(51) Int. Cl. G06Q 10/00; G01S 5/00; G01C 21/00

(52) U.S. Cl. 705/1; 701/213

(57) ABSTRACT

An improved customer service communication system and method, the preferred embodiment utilizing a vehicle's G.P.S. system to communicate via digital or cellular link with a variety of web-based, private, computer or call center networks to access or schedule maintenance for his or her vehicle, maintain said vehicle's service history, download or upload key vehicle operation and maintenance parameters and receive other information of interest, either vehicle directed, personal or of commercial interest, all with the flexibility of being able to access vehicle service also when traveling.

### FIELD OF THE INVENTION

The present invention relates generally to customer service information and management, including appointment scheduling applications and more particularly to systems for the remote scheduling and monitoring of appointments. Furthermore, the invention includes enabling communication through a series of communication means including means housed within a vehicle or other object, moving or stationary. The invention includes analysis of appointment results and customer satisfaction, and in particular, may be used in conjunction with an in-vehicle video screen defined most preferably as a navigation system having a touch screen interface.

### STATEMENT OF GOVERNMENTAL ASSISTANCE

Applicant hereby represents that no part of the subject invention or application has come about with the assistance of government funds or by virtue of a government program.

### BACKGROUND OF THE INVENTION

One co-inventor, Canaday, R., of the instant application previously filed application Ser. No. 09/541,382 for a Method, System and Computer Program Product for Remote Service Scheduling, which application went abandoned in 2002. In October, 2005, a second patent application describing therein substantial improvements in both method and scope of the original method and system was filed, said second patent application having been amended and is currently pending. Said amended second patent application's specification is hereby incorporated by reference as being relevant as background for the instant invention which Applicant believes provides new improvements to such systems and methods as more fully described below.

For service providers who provide services to consumers or other clients, scheduling of appointments can be burdensome both from a time and labor standpoint. In today's fast-moving economy, more and more pressure is felt by both clients and service providers to improve productivity. Given the evolution of high technology tools, service providers and clients generally try to squeeze more work, appointments and hence, results out of each day. On the service provider side, the object is to maximize the number of appointments per employee or day, and for the client, to obtain more results or accomplish more tasks. Commensurate with these pressures is the need for flexibility in the scheduling of appointments—specifically the need for flexibility for re-scheduling, cancelling and otherwise managing appointments. Furthermore, with the advent of multiple means of communication; e.g., internet or web-based, e-mail, land line or cell phone, facsimile transmission and of course, conventional mail, more avenues of communication are available to assist service providers and clients in meeting their goals. However, because of these multiple means of communication, managing customer service and contact has become far more complex, particularly where automation or computer assistance is employed.

Historically, many of the commonly used scheduling applications lacked control. Such applications did not distinguish between client and service provider, and in some cases simply provide a stand-alone computer solution to managing either a service provider's or a client's schedule, or the equivalent with a web-based system. In both situations, security has been traditionally weak; for web-based applications, giving little security for clients to schedule their own appointments, making establishing appointments somewhat random or unstructured, with such problems being exacerbated in situations where a client wishes to cancel or reschedule an appointment.

For applications which schedule meetings, not simply appointments, the solution is more complex. In such situations, the application must require activity from all participants in order to achieve a mutually acceptable appointment. When applied in the service provider setting, the same security issues are present in such applications, and if uncontrolled; i.e., would allow all prospective clients to schedule their own appointments for services, which would leave the service provider with no effective means to control such scheduling, creating chaos in the workplace. In today's world, most consumers of complex, high technology vehicles do not know when specific maintenance services are required, or when preventative maintenance would be advisable. In addition, most consumers may not even know when certain repair services are needed. Even when consumers know their vehicle requires services or repairs they may not remember at a time when it is convenient to schedule an appointment, resulting in sometimes lengthy and ultimately costly delays. Largely absent from these systems is a function to let the client know at the outset that service is needed, independent from the more traditional functions of simply reminding a client that an appointment is scheduled.

As personal and web-based organization tools and systems have evolved, some aspects of the control of scheduling have been attempted. In some cases, web-based applications have allowed service providers to provide clients with a choice of appointment dates and times to select, allowing some control of the flow of clients at the provider's place of business. Further, information from the web-based application has been supplemented by confirmation means, typically a computer generated post card reminder or confirmation, or a human-generated or computer-generated phone call to the client reminding the client of his or her appointment.

More recently, in the case of a phone based confirmation to the client, clients have been offered the choice of either cancelling or rescheduling their appointment. It is here that most of the technology and prior art has reached a plateau.

Important to the service provider is the means to use multiple modes of communication for the establishing, reminding, confirming, cancelling and rescheduling of appointments. Moreover, the need to obtain feedback regarding the scheduling application is imperative to identify flaws in the system, analyze cancellation rates, calculate numbers of “no-shows” etc., to assist the service provider in scheduling his own work hours and staff requirements and further planning future marketing or sales activities.

For the service provider who maintains a detailed database of information on each client, such databases have largely been wanting for feedback as to appointments and have focused primarily on simply adding data about the service appointment, what was done, when it was done, and in some cases, a related link to the work order or its dollar amount. In such cases, little, if any, information is identified about the client's preferences for scheduling, means of communication interface or other satisfaction feedback.

The service provider's database in such instances is largely untapped or even non-utilized as a source of potential demographic information regarding the provider's clients, and is underutilized in terms of providing capability to track the provider's customer satisfaction results or to track the financial performance of his or her business or employees and the value of individual customers.

Recent changes in technology have altered the landscape, adding a further dimension to the available methods of communication; the geographic positioning satellite link or G.P.S. as it is normally called, which is installed in more and more devices such as cell phones, computers and automobiles.

In a preferred embodiment of the present invention, a solution for the customer service challenge is presented based on the automobile adapted G.P.S. system.

Looking at the adaptation of the present invention more closely, we are informed that in the United States alone there are 204 million vehicles and approximately 107 million households. Miller, Leslie, “Cars, trucks now outnumber drivers,” Salon, Aug. 29, 2003. If all vehicles were serviced an average of 3 times per year, the total number of service appointments could reach 612 million. According to Jim Lang of Aftermarket Research™, a market research firm, auto dealerships currently provide service for less than ⅓ of these opportunities. In addition, many vehicles require servicing more frequently than 3 times per year to be maintained in excellent condition.

As taught in applicant's most current pending patent application referenced above, the best technologies available today for: helping remind car owners that it is time for an appointment; permitting easy scheduling and rescheduling of appointments; and sending out appointment reminders, may utilize multiple modes of communication, including but not limited to email, telephone calling and text messaging. Applicant's system works automatically with the auto dealership's information system to gather the necessary relevant data regarding the automobile's owner, the anticipated need for a particular service, the owner's contact information and preference for particular communication means. Further the system contacts the individual with an appropriate message for their vehicle and permits scheduling of an appointment for service at their local dealership.

Further taught in applicant's most current pending application,
“The system queries an auto dealership's management information system or DMS to learn which client (alternately, ‘customer’) had appointments, is due for service, had looked at cars or spoken with a sales representative. Necessary to achieve this is an Overall Data Management System or ‘ODMS’. Once data is recognized and received into the ODMS, a reminder subsystem may utilize the data in the ODMS to contact the customer via telephone, email or text message to remind the customer of the appointment or to follow up on a visit to the dealership.”

The current system works well for many dealerships, but since some messages delivered via direct mail, phone or email are seen by the owner at times when it is not convenient to address the issue, the person neglects to make an appointment and the service is not performed or is substantially delayed, risking potential damage to the vehicle, degradation of its condition and in extreme cases, even unsafe operation. In addition, most auto services are performed by local shops, not connected to the technology listed above and the owner does not maintain an accurate record of their car's service.

Suffice it to say, convenient methods to schedule an appointment along with simple reminders that it is time for service or repair can help automobile owners maintain their vehicles in excellent condition to maximize long-term performance and reduce the potential of larger “downstream” costs.

With the increased usage and sophistication of in-vehicle Global Positioning Systems (G.P.S.), there is a substantial opportunity to improve vehicle monitoring, provide more accurate and timely service reminders, improve communications with the vehicle's owner and provide substantially improved, automated and Owner-entered vehicle record-keeping right from the vehicle. The kinds of G.P.S. systems range from aftermarket, limited capability systems which primarily provide guidance to drivers who have specified a desired destination for their travel to original equipment manufacturer supplied systems with multiple functions and capabilities for vehicle monitoring, interface with climate controls, audio systems, and other command and control functions.

One such system already being used for limited vehicle management is General Motors' “Onstar®” system. General Motors' system offers a variety of features to vehicle owners such as: hands-free calling through a cellular telephone network for a fee through a traditional cellular system provider.

A manned call center permits the driver to query such things as the location of restaurants, hotels, and in cases where the driver has, for example, left his or her keys in the vehicle, inform the manned call center which can issue a command through the system to unlock the car. Other commands are available such as the flashing of lights and honking of the vehicle's horn to “announce” its location to the driver in case he or she is having difficulty in finding the automobile in an airport or shopping mall parking lot.

Further, information is automatically sent to the call center when certain vehicle events occur, such as the deployment of airbags which would suggest a collision has occurred. Notification via the cellular link can be made to emergency service providers at 911 in such cases.

Other monitoring by the G.P.S. system itself includes providing G.P.S.-derived coordinates to alert police or other interested parties of the vehicle's location. This may, in the case of OnStar®, be in conjunction with a communications link to a human-based system, or simply a remotely actuated link to determine vehicle location as in the case of LOJACK®, an anti-theft method which has been used to find stolen vehicles for many years now.

Of course, one of the main features of the G.P.S. system is to provide navigation information to the driver to assist in finding a destination and route, even providing verbal driving instructions, as previously mentioned.

Some basic engine parameters are also monitored by the General Motors system, Typically checked monthly, and where the user requests, may generate an email status update of said parameters via a separate computer system linked with the internet.

What is needed to take the scheduling, confirmation and analysis tools which manage vehicle owner's maintenance regimes to the next level, is a system which provides the additional communication means of using the vehicle's own systems to communicate with the owner and utilize the information already available through systems already in place in the vehicle.

### SUMMARY OF THE INVENTION

Applicant's preferred embodiment gathers data from auto service centers including automobile dealerships as has been described in applicant's current pending application. For vehicles equipped with a Digital Communications System connected to a G.P.S. System, Applicant's system will also communicate to the Car Owner important vehicle and service information via a Cellular or Digital Wireless Communications Carrier. In one form, Applicant's system employs the OEM supplied G.P.S. installed in the vehicle to take advantage of the existing touchscreen and voice communications capabilities. Messages can be delivered via voice, G.P.S. display or both. In addition to communications directed to the Owner through the vehicle's G.P.S. system, Applicant's system will communicate a complementary message to the Owner via the Owner's home phone, email or text account as described in Applicant's current pending application. Further, the owner will have access to service records via the internet which have been entered via G.P.S., a participating service provider or manually by the owner via the internet. If the vehicle is appropriately equipped, the system will provide automated interaction for the services provided by the On-Star “Manned Call Center” described above.

It is an object of the present invention to notify the driver when service is due, automatically collecting vehicle operational information directly from the vehicle, a service organization of a Dealership, or alternatively, information entered by the owner into the website or any combination thereof. Notification may be accomplished via the G.P.S. screen upon start-up of the vehicle so that the driver is not distracted when operating the vehicle. The system may in concert with the G.P.S. notification send a message to the Owner via phone, email or text message, as selected by the owner as a confirmation of the message sent to the vehicle via the Digital Communications System and the G.P.S. This is helpful in cases where the message was delivered to the vehicle when someone other than the vehicle owner is driving or when it is inconvenient to act; e.g., when en route and away from home.

It is a further object of the present invention to locate the nearest enrolled Dealership or Garage capable of servicing the vehicle and check for an open appointment slot (automatically or when requested) providing a query to the driver regarding establishing an appointment. In the event the vehicle is on a cross-country run, the system would locate a dealership or garage along the route and offer alternatives to scheduling along route, at the destination, or upon the return trip home.

It is a further object of Applicant's invention to automatically contact the Owner in special circumstances such as when the system detects vehicle alarms, contacting the owner via cell phone, home phone, email, or text message.

It is a further object of Applicant's invention to detect if the lights are left on or there is a short in the vehicle's electrical system thereby draining the battery, prompting messaging the owner as already described.

It is a further object of Applicant's invention to allow web browsing by the owner via the G.P.S. screen, or an automated link via the internet or other communication means allowing the owner to confirm the vehicle's location.

It is a further object of the present invention to provide G.P.S. enhanced interface between the vehicle owner and dealerships or service providers as set forth in Applicant's current pending application, offering service specials and sale promotions that appear at the appropriate time. Said offers may be based on the vehicle's performance and driving parameters in the form of a timely notification via the G.P.S. Screen, or via the other modes of communications.

It is a further object of the present invention to send digital commercial messages to the G.P.S. for viewing by the owner.

It is a further object of the present invention to provide a timely reminder to the owner or driver at one or more prescribed intervals in advance of a scheduled appointment including the morning or day of the appointment. During such a notification, the system may play a reminder message upon vehicle start-up, offering to suggest a route to the dealership, employing the standard functionality of the on board navigation system.

It is a further object of the present invention to permit the owner to select options to delete or redisplay the reminder at a later time by pressing on the touchscreen or even by verbal response.

It is a further object of the present invention to provide automatic updates to the owner's service history via the internet including events managed through said G.P.S. system.

It is a further object of the present invention to allow manual entry of data into the owner's history in the event the owner conducts unscheduled maintenance, or has service performed by a dealer or garage not currently identified with owner or the system.

It is a further object of the preferred embodiment to provide the owner access to the complete vehicle history via the G.P.S. system.

It is a further object of the preferred embodiment to provide the functions described herein through non-OEM or after-market G.P.S. systems, utilizing at a minimum, the communications means provided thereby, and where capable, vehicle monitoring and other capabilities consistent with OEM systems.

It is a further object of Applicant's invention to permit the communication of promotional offerings from participating dealers, garages, or other commercial enterprises such as hotels, restaurants, or other wholesale and retail concerns through the communications link to the G.P.S. system. Such offerings could be location driven based on the current or planned route the vehicle is traveling and would specifically relate to real time maintenance or operational needs of the owner's vehicle.

It is a further object of the present invention to provide interface with the vehicle owner's web-based calendar utilizing speech, menu-driven and data entry modes via the G.P.S. system and its touchscreen.

On the whole, Applicant's preferred embodiment utilizes a vehicle's G.P.S. system to communicate via digital or cellular link with a variety of web-based, private, computer or call center networks to access or schedule maintenance for his or her vehicle, maintain said vehicle's service history, download or upload key vehicle operation and maintenance parameters and receive other information of interest, either vehicle directed, personal or of commercial interest, all with the flexibility of being able to access vehicle service also when traveling, as more fully described below.

### BRIEF DESCRIPTION OF THE DRAWINGS

FIG. 1 is a process flow diagram showing the communication relationship between a vehicle, public communications infrastructure and applicant's system;

FIG. 2 is a process flow diagram showing the communications relationships between the vehicle owner, applicant's system, third party wireless communications providers, automobile dealerships and service providers, the owner's vehicle and its G.P.S. system; and

FIG. 3 is a process flow diagram of information between the hardware of the G.P.S. system, user interface, and microprocessor control allowing functionality among same.

### DETAILED DESCRIPTION OF THE INVENTION

Applicant's system for purposes of this application will be termed a “Customer Information Management & Analysis system, or “CIMA”.

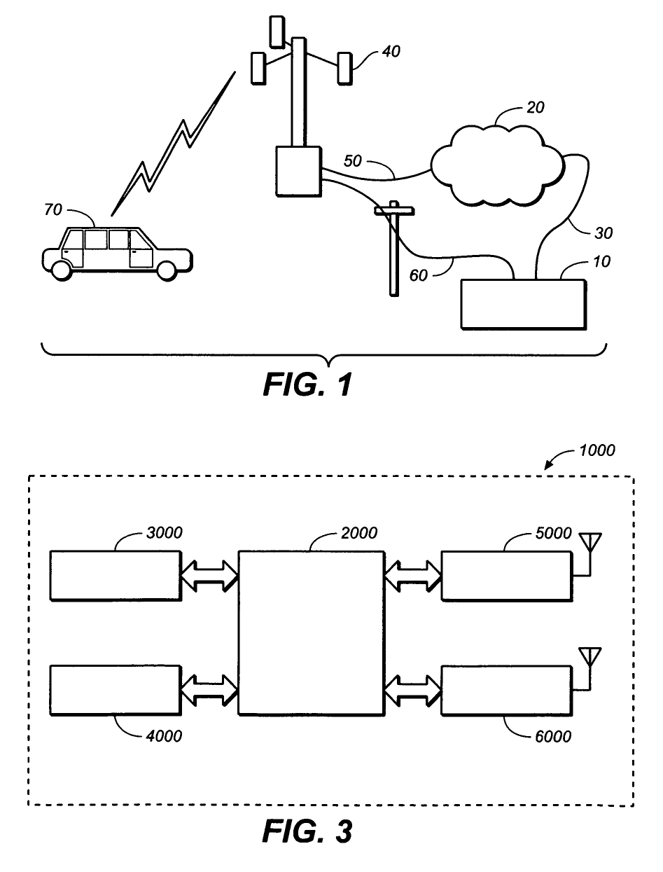

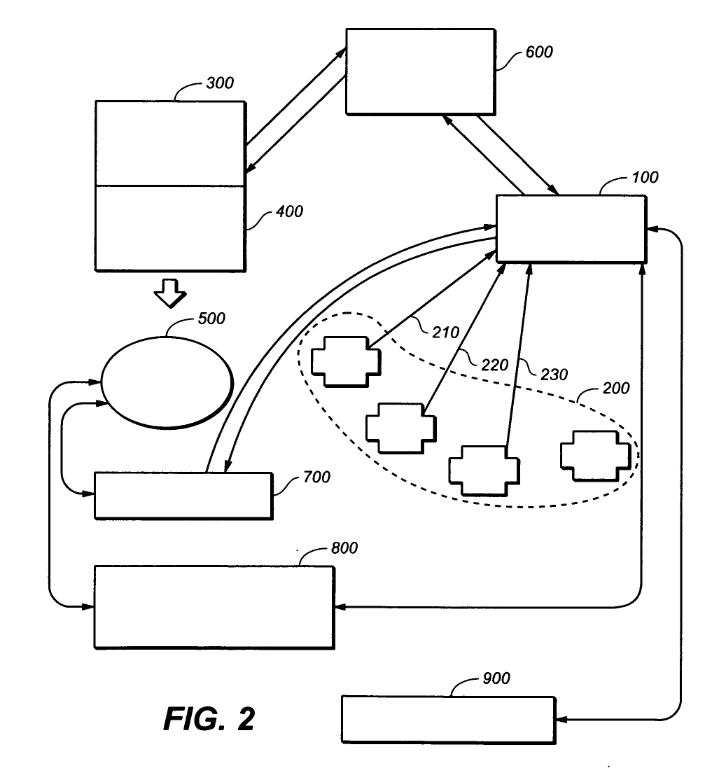

As shown in FIG. 1, CIMA 10 is in communication with the internet, 20 by means of communications link 30, which can be via high-speed digital communication line, land line or wireless means. Internet or world wide web system 20 is in communication with public infrastructure 40 by communication means 50, again, said means comprising a variety of communications links.

CIMA 10 is also in communication with infrastructure 40 as shown through its links through internet 20, or alternatively, directly through wired communication means 60. Vehicle 70, by virtue of its cellular or wireless link and G.P.S. system, is in communication with infrastructure 40, thereby allowing it to communicate to CIMA 10 by at least one communication means.

As shown in FIG. 3, CIMA 100 will gather data from auto service centers 200 by a variety of information means. Info means 210 represents digital download of information directly to CIMA 100. Info means 220 represents land line communications means meaning either a phone call, or fax communication. Info means 230 represents either email or text messaging from said service center into CIMA 100. For vehicles equipped with the Digital Communications System 300, which is in direct communication with G.P.S. System 400, CIMA 100 will be able to communicate with vehicle owner 500 important vehicle and service information via the Digital Wireless Communications Carrier 600, which can be a typical cellular or wireless carrier such as Verizon or Cingular. Such communication may be on an occasional basis or at predetermined intervals.

In one form, owner 500 will use an OEM supplied or aftermarket G.P.S. system 400 which is supplied with said vehicle when new to take advantage of the its integrated touchscreen and voice communications capabilities. Messages can be delivered to Owner via audible voice messages, by text on the G.P.S. display, or both. In addition to communications to owner 500 through G.P.S. 400, CIMA 100 will communicate complementary messages to the owner 500 via the owner 500's home phone, email or text account 700. CIMA 100 will permit the owner to access service records via the internet which have been entered via G.P.S. through said Digital Wireless Communications Center “DWCC” 600, or manually via website 800, maintained by CIMA 100. If the vehicle is appropriately equipped, CIMA 100 will provide automated interaction for the services provided by a “Manned Call Center” such as OnStar® as described above via DCS 300.

Digital Communications System 400 is designed to cost-effectively perform several functions. First, the system can hold electronic templates for messages displayed on G.P.S. 400, as well as touch screen and voice messages to be broadcast via G.P.S. 400's integrated communications system.

In use, said templates are initiated by a small, 1 kilobyte or less signal from CIMA 100 transmitted through DWCC 600. Said activation message carries at least the information required to select and activate the specific message on said template based on pre-set parameters; e.g., a standard message such as, “You are due for an oil change.”

For service providers that are linked to said owner or who agree to use Applicant's system custom communications templates using provider-selected graphics and wording may be provided along with an Installation System (not shown) that will allow service personnel to place said customized template in DCS 300 on said vehicle. When CIMA 100 sends an activation message, said customized template and wording could then be used for said communication with owner 500.

DCS 300 is capable of receiving customized electronic messages that do not require the use of templates. As digital communications continue to advance and costs are reduced, it is anticipated that electronic templates will no longer be required for cost-effective use of such systems. In the preferred embodiment, DCS 300 receives messages as any similar computer or mobile communications device that can connect to the internet via wireless providers such as Verizon or Sprint or other current (Wi-Fi) or future wireless means.

DCS 300 will also permit owner 500 to select preferences via said templates displaying service providers which are known or near, also selecting communications means preferences such as email, text messages or phone calls, or conversely, which of said communication means client wishes excluded. It is anticipated that such preferences may be password protected and reset by use of the previously mentioned installation system or by CIMA 100 via DWCC 600.

Such password management may also be accomplished through web-based means 800.

Thus, DCS 300 can be set at the automobile factory, at a dealership or service provider using the Installation System (not shown) or by the user via GPS 400's TouchScreen or CIMA 100 with specific preferences concerning when communications are to be displayed or audibly communicated regardless of whether the automobile is stationary, just being started, or even the number of times a communication is repeated when no response is recorded.

DCS 300 can also record and send responses from owner 500 to CIMA 100, for example electronically by pressing a touch screen selection or a verbal response if G.P.S. 400 is so enabled.

DCS 300 can either send an entire response back to CIMA 100 in the case of verbal responses, or can summarize the user's response with a short burst message (i.e. yes, no, date and time for appointment, accept, change, delete, etc). An entire response would be valuable when the owner wished to communicate additional information to the dealership, such as an additional concern about the car to be checked by the dealership or even the need to reserve a loaner car.

DCS 300 is provided with means to receive information from a vehicle's electronic diagnostic system. When certain and selected warnings are triggered by the diagnostic system, typically an “On Board Diagnostic” or “OBD” system, that information would be transmitted to CIMA 100 and owner 500, informing said owner of said warning, and prompting said owner to select options for service, appointments, later repeat of said warning or other options for service or notification. Just as owner 500 would be contacted via said G.P.S. 300 and a message sent to CIMA 100 for additional telephone or electronic communications via email to the vehicle's owner, said forms of messages also including “.wav” format audio messages and other messages which may be transmitted digitally and played via GPS 300.

Upon owner 500's selection, DCS 300 will display on G.P.S. 300's screen nearby service centers for immediate service or contact CIMA 100 to determine the nearest known dealership or service center qualified to service the vehicle.

DCS 300 can retain in memory location and contact information for all participating or known dealerships qualified to service the specific vehicle. Such information may also be updated continually by CIMA 100 by said various communications means. A variety of databases allowing such information to be confirmed currently exist, such as “Google Maps” or another database shown as databank 900. Such updating can be initiated by owner 500 at any time or by predetermined schedule from CIMA 100. CIMA 100 may also add features for communicating error codes such as “Air Bags Deployed” to automatically communicate to a manned call center via a wireless digital communications network.

FIG. 3 shows a Customer Set 1000 which is comprised of but not limited to four functions that are controlled by Microprocessor Controller 2000. User interface 3000 is comprised of but not limited to a touch screen display unit, and/or series of buttons for user activation of response functions and circuitry for voice recognition. User interface display 3000 will show information from the other interfaces such as OBD2 (“On Board Diagnotic 2”) Module interface 4000, the G.P.S. receiver 5000 and the Communications module 6000. OBD2 4000 monitors multiple vehicle systems and parameters and generates typically a 5 digit “Diagnostic Trouble Code” (“DTC”) to indicate the so-coded system requiring service, and is standard in the industry. This type of information in 2003 became part of a standard communications protocol in the automobile industry named Controller Area Network or CAN.

Microprocessor Controller unit 2000 handles all the initialization, processing of input and output functions with said other units. Microprocessor Controller unit 2000 is comprised of memory, time keeping, I/O and power supply circuitry. G.P.S. unit 5000 is a minimum 12 parallel channel type receiver supporting standard NMEA-0183 and NEMERIX binary protocol providing position data to Microprocessor Controller unit 2000. Data from G.P.S. unit 5000 is used for street navigation and detailed maps. An antenna (not shown) is also included with this module which may be integrated within Customer Set 1000 or may have a connector (not shown) for external connection.

OBD2 unit 4000 interfaces to a vehicle OBD2 standard connector of a vehicle and handles ISO15765-4 (CAN), ISO14230-4 (KWP2000), ISO9141-2, J1850 VPW and J1850 PWM information protocols. Communications module 6000 may comprise one or more different communications technologies such as cellular AMPS, TDMA, CDMA, GSM, and PCS and use services such a SMS. In addition to these technologies module 6000 may also support wireless technology in the IEEE 802.11, 15, 16 specification—including the wireless protocols 802.11a, 802.11b, 802.11g, 802.15.1 and 802.16e-2005.

While the invention has been described in connection with what is presently considered the most practical and preferred embodiment(s), it is to be understood that the invention is not limited to the disclosed embodiment(s) but, on the contrary is intended to cover various modifications and equivalent arrangements included within the scope of the appended claims.

What is claimed is:

1. A method for customer information management which utilizes a vehicle-based digital communications system to send and receive information between a vehicle owner or operator and a service provider comprising:
a vehicle equipped with a digital communications system capable of communicating with a digital communications carrier, said system also in communication at predetermined intervals with said vehicle operator or owner, said vehicle further provided with an on-board diagnostics sub-system, said sub-system in communication with said digital communications system; and
a customer information management and analysis controller, said controller in communication with said carrier enabling communication with said communications system and said diagnostics sub-system, enabling said controller to send and receive information between said owner or operator and said service provider.

2. The method of claim 1 wherein said vehicle is provided with a GPS navigation system, said navigation system in communication with said communications system, enabling said controller to communicate with said owner or operator thereby.

3. The method of claim 1 further comprising templates programmable into said communications system such that said controller may analyze information received by said diagnostics system and communicate with said owner or operator by use of said templates.
